(19) United States
(12) Patent Application Publication
(10) Pub. No.: US 2023/0151759 A1
(43) Pub. Date: May 18, 2023

(54) SATELLITE HAVING ACTIVELY COOLED ELECTRIC THRUSTER

(71) Applicant: Earth Observant Inc., El Granada, CA (US)

(72) Inventors: Nathan Rosenblad, El Granada, CA (US); Christopher Thein, El Granada, CA (US)

(21) Appl. No.: 17/987,528

(22) Filed: Nov. 15, 2022

Related U.S. Application Data
(60) Provisional application No. 63/279,873, filed on Nov. 16, 2021.

(51) Int. Cl. F01P 1/06; B64G 1/40; F03H 1/00

(52) U.S. Cl. CPC F01P 1/06; B64G 1/405; F03H 1/0037; F25B 9/145

(57) ABSTRACT

A satellite having a cooling system to remove heat from an electric rocket engine using a working fluid. The cooling system can include a pump that circulates working fluid along a cooling loop between the rocket engine and a radiator. The cooling system can also utilize thermoacoustic, Stirling refrigeration, and/or heat pipe techniques. One or more reservoirs can be provided to store the working fluid, and in some forms a secondary reservoir can be provided to aid in management of a center of mass of the satellite. A fluid reaction loop can be provided in which working fluid is accelerated to impart a torque on the satellite. In some forms, the working fluid can be utilized as both a coolant and a propellant for the rocket engine. The electric rocket thruster can also include one or more internal pathways for the conveyance of working fluid.

### CROSS-REFERENCE TO RELATED APPLICATIONS

The present application claims the benefit of U.S. Provisional Patent Application Ser. No. 63/279,873, filed Nov. 16, 2021, which is incorporated herein by reference in its entirety.

### FIELD OF THE DISCLOSURE

The present disclosure generally relates to low earth orbiting satellites, and more particularly, but not exclusively, to low earth orbiting satellites having cooled electric rocket engines.

### BACKGROUND

Electric rocket engines used in satellite applications can provide an efficient means of propulsion while generating heat. Some existing systems have various shortcomings relative to certain applications. Accordingly, there remains a need for further contributions in this area of technology.

### SUMMARY

One embodiment of the present disclosure is a unique satellite with a cooled electric rocket engine. Other embodiments include apparatuses, systems, devices, hardware, methods, and combinations for cooled electric rocket engines used in satellites. Further embodiments, forms, features, aspects, benefits, and advantages of the present application shall become apparent from the description and figures provided herewith.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIGS. 1A-1D illustrate side, top, front, and top views, respectively, of an exemplary low earth orbiting satellite.

FIG. 2 depicts an exemplary embodiment of a cooling system for a cooled electric rocket engine.

FIG. 3 depicts an exemplary embodiment of a cooling system for a cooled electric rocket engine that includes a pump to circulate working fluid.

FIG. 4 depicts an exemplary embodiment of a cooling system for a cooled electric rocket engine having a pump useful to circulate a refrigerant working fluid.

FIG. 5 depicts an exemplary embodiment of a cooling system for a cooled electric rocket engine.

FIG. 6 depicts an exemplary embodiment of a cooling system for a cooled electric rocket engine that includes a heat pipe.

FIG. 7 depicts an exemplary embodiment of a cooling system for a cooled electric rocket engine having a working fluid reservoir.

FIG. 8 depicts an exemplary embodiment of a cooling system for a cooled electric rocket engine having a working fluid reservoir and propellant metering system.

FIG. 9 depicts an exemplary embodiment of a cooling system for a cooled electric rocket engine having a fluid reaction loop.

FIG. 10 depicts an exemplary embodiment of a cooling system for a cooled electric rocket engine having adapted to pump working fluid and alter a mass property of a satellite.

FIG. 11 depicts an exemplary embodiment of a cooling system for a cooled electric rocket engine adapted to pump working fluid to be used in a fluid powered device.

FIG. 12 illustrates a cross section view of a portion of an annular region of an electric rocket engine having a cooling system that includes a plurality of pathways within and/or attached to the electric rocket engine to carry working fluid.

Corresponding reference numerals are used to indicate corresponding parts throughout the several views.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

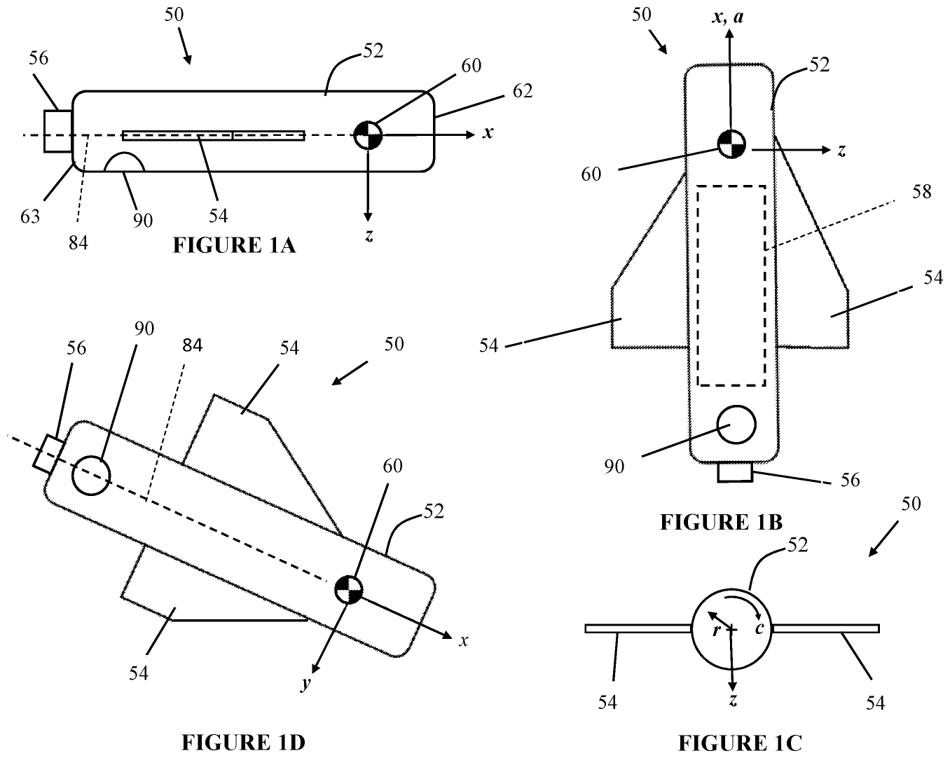

With reference to FIGS. 1A-1D, a low earth orbiting satellite 50 is disclosed which can be configured to collect sensory information during orbital flight. The low earth orbiting satellite 50 may be referred to herein as a satellite, vehicle, orbital vehicle, etc. No limitation is hereby intended with respect to various usages of the term as all will be understood to refer to the same. Also as will be appreciated by those of skill in the art, the schematics presented in FIGS. 1A-1D are intended to depict various functional components of the satellite 50 and do not imply specific orientation, dimensions, arrangement of components, and/or numbers of components.

The satellite 50 can be constructed for operation at low earth orbit altitudes in the thermosphere, anywhere at altitudes ranging from at least 50 miles and beyond, including but not limited from 50 miles to 600 miles, and in some situations preferably from 50 miles to 23,000 miles, where images or other sensory information of earth can be obtained through any variety of sensors. In some forms the satellite 50 is configured to transmit data in real time, but in other forms and/or modes of operation the satellite 50 can process information onboard and transmit a reduced data set.

The satellite 50 generally includes a longitudinally oriented body (or fuselage) 52, one or more fins 54 that can be used as solar arrays and/or antennas, and an electric rocket engine 56, also referred to herein as a rocket thruster 56, useful to assist in countering the effects of drag while operating in low earth orbit. The body 52 is sized to accommodate a payload 58 that can include, at least in part, a remote sensing system, such as, that can include several different components (some of which may be described and/or illustrated later in the application). According to certain embodiments, the payload 58 is a telescopic payload.

The rocket thruster 56 can take a variety of forms. For example, according to certain embodiments the rocket thruster 56 is an ion thruster, including, for example, a Hall Effect thruster. While reference may be made below to particular types of electronic rocket thrusters 56, such as, for example, Hall Effect thrusters, no limitation is hereby intended that the rocket thruster 56 in any given embodiment be limited to being a Hall Effect thruster, or any other type of thruster, unless indicated explicitly to the contrary. Further, although the illustrated embodiment depicts a single block to represent a rocket thruster 56, it will be appreciated that additional rocket thrusters 56 can be used on the satellite 50. For example, multiple rocket thrusters 56 can be used at the location of the single block represented in the figures. Additionally, one or more rocket thrusters 56 can be located elsewhere around the satellite 50. For example, multiple rocket thrusters 56 can be festooned at multiple locations and/or on multiple surfaces to provide specific thrust vectors with regard to the bulk motion of the satellite 50. As will be appreciated, the rocket thruster 56 can be used to enable efficient orbital maneuvers, one example of which includes drag makeup in very low earth orbit missions.

To aid in some of the discussion herein, a Cartesian coordinate system has been illustrated in FIGS. 1A-1D and which includes an x-axis generally along the direction of the longitudinally oriented body 52, a y-axis out a lateral direction of the body 52, and a z-axis out the bottom of the satellite 50. While in orbit, the x-axis will generally be in the direction of orbital velocity, the z-axis will point to the earth, and the y-axis will point out the side of the satellite 50. The axis system can be defined to uphold the so-called ‘right hand rule.’

As will be appreciated, the origin of the axis system can be anywhere in the satellite 50, and for purposes of illustration is forward of the center of mass (CoM) 60 as shown in FIG. 1D. As used herein, terms such as ‘forward’ or ‘aft’ generally describe a relative position along a longitudinal axis, or axis of extension, 84 of the satellite 50, with ‘forward’ intended to denote a position away from the rocket thruster 56 out of a leading edge 62 of the satellite 50 and ‘rearward’ intended to denote a position toward the rocket thruster 56 and out the back 63 of the satellite 50 or fuselage 52. Similarly, terms such as ‘lateral’ or ‘starboard’ or ‘port’ generally describe a relative position along the lateral axis y, with ‘starboard’ intended to denote a position in the positive y direction and ‘port’ intended to denote a position in the negative y direction.

As seen in FIG. 1C, to further aid in alternative and/or additional aspects of the description herein, a polar coordinate system can be defined about the fuselage 52 and which includes a radial direction ‘r’, circumferential direction ‘c’, and an axial direction ‘a’ (which is generally in the same direction as Cartesian axis x). Though the cross section in the schematic shown in FIG. 1C is circular, no limitation is hereby intended for the cross sectional shape. Nevertheless, the polar coordinate system can still be used to denote relative positioning for purposes of description herein. For example, the cross sectional shape of the fuselage 52 can be octagonal where use of the polar coordinate system can still be used to denote relative positioning within and about the body or fuselage 52.

Various embodiments disclosed herein can have features to cool the rocket thruster 56. For example, an actively cooled Hall Effect thruster, among other types of rocket thrusters 56, can enable a higher power density at higher efficiency, while reducing the physical implementation package size. One embodiment of such a system would utilize the propellant as both a propellant and a working fluid. A combination of the management and storage system of propellant/working fluid can further provide volume and weight savings. Various embodiments as will be described further herein can use mechanical pumps, thermal gradient, or phase change to induce flow of working fluids. The working fluid, which is referred to herein as a heat exchange fluid, can be a coolant or refrigerant, and can take the form of a gas, liquid, or multiphase, as well as combinations thereof. Further, heat transfer can be redistribution or heat pump based. Various embodiments described herein can be operated such that the heat rejection of the rocket thruster 56 can be significantly higher when using a working fluid than realizable through passive cooling of a rocket thruster 56 in a similar size package. This can enable multiple potential outcomes, such as operating the rocket thruster 56 for longer periods of time due to limitations of thermal buildup and runaway. The rocket thruster 56 can also be operated at a significantly higher power output since heat can be more effectively controlled through use of the working fluid.

Operating an active cooling system can be accomplished in a continuous or non-discrete power level, or through a function such as a sine wave or arbitrary function. Cooling power output can be dictated through operational indications. Furthermore, working fluid disposition within the body or fuselage 52 can be used to adjust body properties of the craft or satellite 50 overall, including, for example, with respect to the center of mass 60 and moment of inertia, among other properties. In some forms, the flow of working fluid can impart reaction forces to the satellite 50 such that the working fluid in effect can be operated as a Reaction Control System or other system that can be used in the operation of the satellite 50 including, for example, utilized in connection with creating reactive forces that can alter an orientation or trajectory of the satellite 50. Working fluid can also be moved between storage locations in order to adjust center of gravity of the body or fuselage 52 and or other mass property. Various embodiments can also use pumped cooling fluid to alter either the spacecraft center of mass or the spacecraft angular momentum, either through movement of the fluid mass of the working fluid, or hydraulic/pneumatic mechanisms that utilize the working fluid.

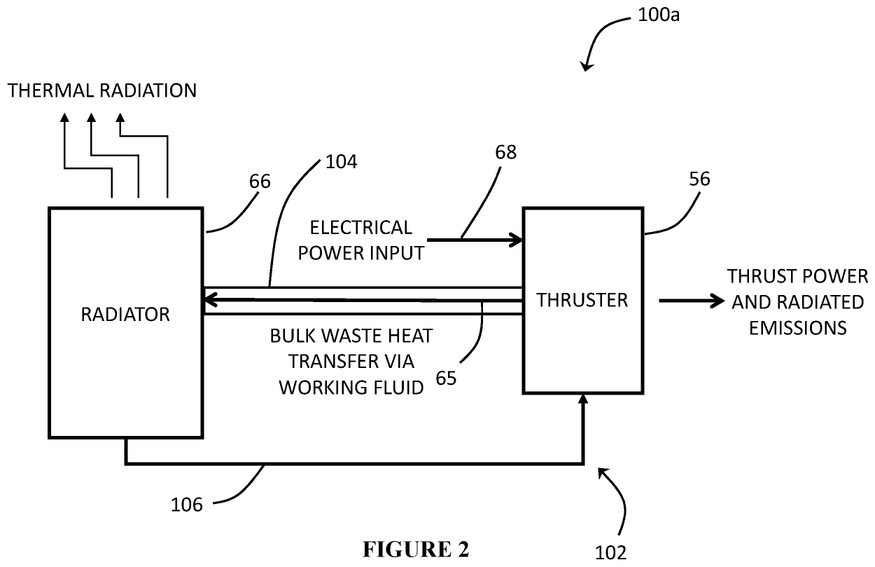

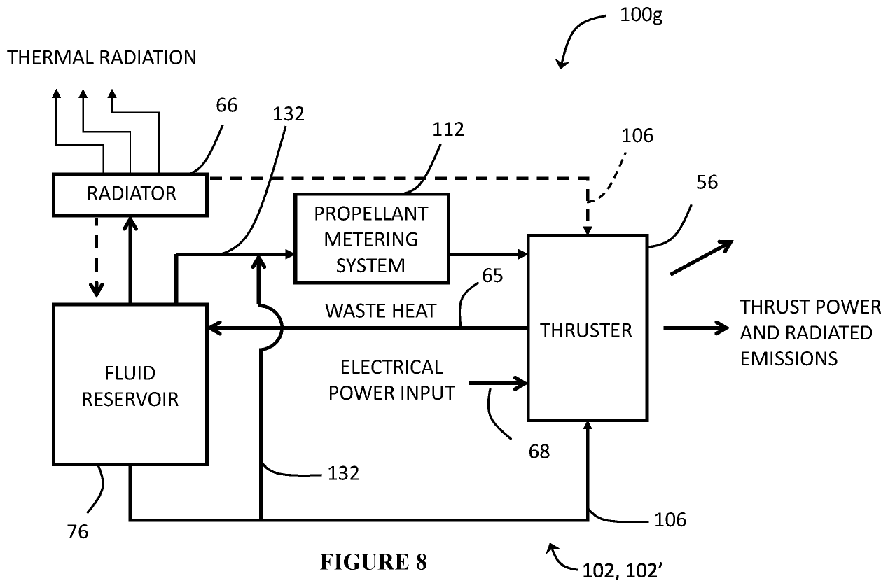

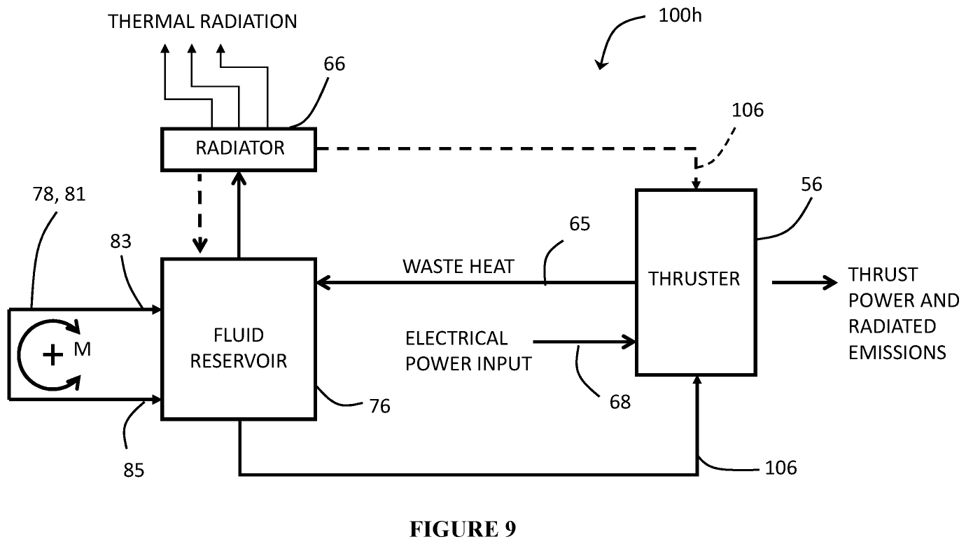

Various configurations of cooling the electric rocket thruster 56 are depicted in FIGS. 2-11 where like reference numerals refer to like elements. It will be appreciated that unless described to the contrary, one or more features of any given figure can be combined with one or more features with one or more of the other figures. To set forth just one non-limiting example, feature(s) of FIG. 8 can be combined with features of FIG. 9, among potentially other combinations.

FIG. 2 depicts an embodiment of a cooling system 100a for a cooled rocket thruster 56 in which waste heat 65 is conveyed from the thruster 56 to a radiator 66 that is configured and/or oriented on the satellite 50 to radiate heat (e.g., “Thermal Radiation” in FIG. 2) into space and away from the satellite 50. The waste heat 65 can be conveyed from the rocket thruster 56 via a working fluid, such as, for example via a coolant or refrigerant, among other working fluids. The radiator 66 can therefore be fluidly coupled to the rocket thruster 56, such as, for example, via one or more conduits that can be used to transport the heated working fluid from the rocket thruster 56 to the radiator 66, as well as return cooled working fluid from the radiator 66 to the thruster 56. For example, as seen, the cooling system 100a can include a cooling loop 102 having one or more return lines or conduits 104 through which the waste heat 65 entrained in the relatively hot working fluid is conveyed from the rocket thruster 56 to the radiator 66, and one or more supply lines or conduits 106 through which cooled working fluid is generally transported from the radiator 66 to the rocket thruster 56.

As will be appreciated, the rocket thruster 56 can be powered by an electrical power source and receive electrical power 68 (e.g. “Electrical Power Input” in FIG. 2) through a power connection. Only a percentage of the total electrical power that enters the rocket thruster 56 is converted into energy in the form of thrust work of the rocket thruster 56, or is radiated into the local plasma environment. The remaining electrical power is converted into thermal power or energy that is to be radiated by the rocket thruster 56, such as, for example, via the thruster body or other structure of the rocket thruster 56 to maintain system thermal equilibrium. In the embodiment depicted in FIG. 2, such thermal energy or power is instead actively shuttled out of the rocket thruster 56 via the working fluid. Such a configuration can enables higher electrical power input than would normally be possible with thruster body radiated rejection alone.

The radiator 66 can take on any size and shape, and be made from any number of components to take on any type of radiator configuration. For example, according to certain embodiments, the radiator 66 can be affixed, integrated, and/or part of the fuselage 52 in a manner that minimizes the radiator 66 contributing to atmospheric drag. Further, the radiator 66 can be positioned to radiate heat (“Thermal Radiation”) in a direction neither toward the sun nor the earth during normal orbiting of the satellite 50. Thus, for example, the radiator can be positioned along a vertical side of the fuselage 52.

In some forms, the radiator 66 can include a single radiator, but in other forms the radiator 66 can include multiple separate radiators 66. Further, according to certain embodiments, one or more of the multiple radiators 66 can be in various configurations with respect to other radiators 66, including, for example, coupled in parallel and/or in series with respect to one or more other radiators 66. Additionally, the flow of working fluid to the radiator(s) can be controlled by the inclusion of one or more fluid control valves that can be positioned between the electrical rocket thruster 56 and the radiator(s) 66.

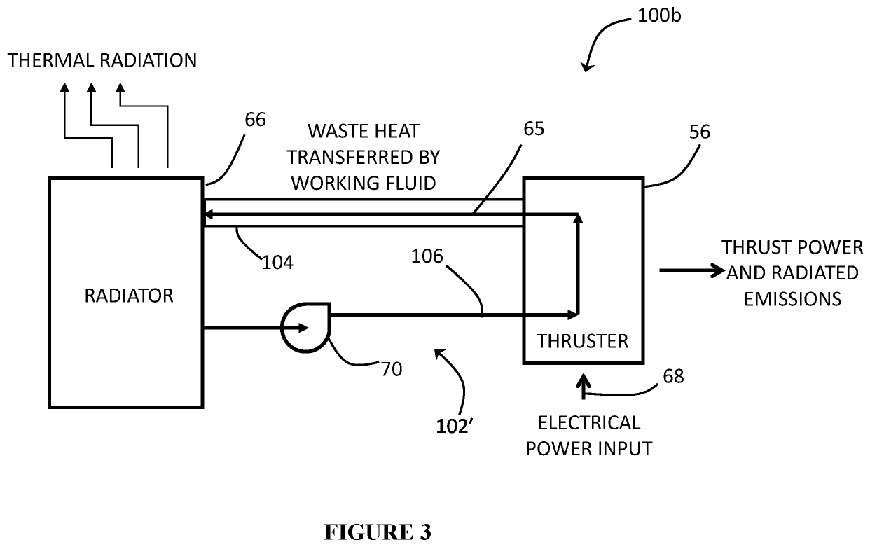

FIG. 3 depicts an embodiment of a cooling system 100b for a cooled rocket thruster 56 that includes a pump 70 that is configured to circulate working fluid. The pump 70 is placed in fluid communication with the radiator 66 and the rocket thruster 56. Moreover, as seen in FIG. 3, unlike the cooling loop 102 shown in FIG. 2, the cooling loop 102′ is an active cooling loop 102′ in which the pump 70 provides a force to at least assist in the transport of the working fluid. In some forms, in connection with influencing the flow of working fluid, the rocket thruster 56 is to be hotter than radiator 66. At least compared to designs in which a relatively large mass of solid material, such as, for example, copper, is used for heat transfer, the pumped cooling loop 102′ formed in this illustrated configuration can help to reduce thermal impedance to the final radiating surface external from the rocket thruster 56.

The illustrated embodiment locates the pump 70 at or around the return line 106 and/or outlet of the radiator 66 such that the pump 70 receives cooled working fluid from the radiator 66 that is to be supplied to the rocket thruster 56. However, the pump 70 can be located at any point in the cooling loop 102. Additionally, the cooling system 100b can include a plurality of pumps 70 that can be located at different locations along the cooling loop 102, including one or more pumps 70 at the outlet of the radiator 66, the inlet of the electric rocket engine 62, and/or along the return line 106, and one or more pumps at an inlet of the radiator 66, the outlet of the electric rocket engine 62, and/or along the supply line 104. Further, according to certain embodiments, the pump 70 can be a mechanical pump and can take on any form such as piston driven pumps, diaphragm pumps, and pumps with an impeller, among other types of pumps. Although not shown, the pump can be connected to an electrical power supply, which in some forms is the same electrical power supply for the rocket thruster 56.

The pump 70 is used to provide propulsive force to encourage a circulating flow of working fluid between the radiator 66 and the rocket thruster 56, which can take on a variety of forms such as periodic flow, pulsed flow, continuous flow, etc. In addition, in some embodiments the pump 70 can be configured to provide a broad range of flow rates to accommodate changing thermal demands from the rocket thruster 56 and/or available heat transfer rates from the radiator 66. Though the working fluid is illustrated in this and other embodiments as being routed through the schematic block of the rocket thruster 56 (which in some figures is shown via a dashed line), it will be appreciated that the working fluid can be routed to any suitable place of the rocket thruster 56, including, for example, a back side of a shell or internal passageway of the rocket thruster 56, among other locations, suitable for the working fluid to receive heat generated from operation of the rocket thruster 56.

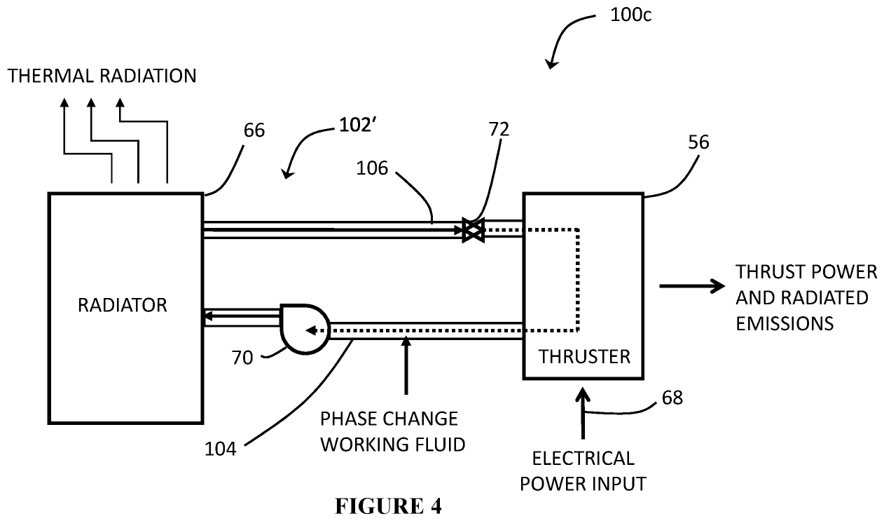

FIG. 4 depicts another embodiment of a cooling system 100c for a cooled rocket thruster 56 in which the pump 70, such as, for example, a mechanical pump, is utilized to provide a force for a displacement of working fluid between the rocket thruster 56 and the radiator 66. As with the embodiment shown in FIG. 3, one or more pumps 70 can be utilized in connection with a cooling loop 102 having supply and return lines 104, 106. Further, the pump 70 can be connected to an electrical power supply, which in some forms can be the same electrical power supply for the rocket thruster 56. According to certain embodiments, the working fluid utilized with the cooling system 100c shown in FIG. 4 is a refrigerant. According to such embodiments, the refrigerant can undergo a phase change, the different phases of the working fluid being generally represented in FIG. 4 by solid and dashed lines that represent the working fluid, during the process such that a negative differential temperature can exist between the electric rocket engine thruster 56 and the radiator 66 against which the energy is pumped. Thus, according to such embodiments, the rocket thruster 56 can be colder than the radiator 66. Alternatively, according to other embodiments, such a cooling loop 102 of working fluid can be accomplished with non-phase-change high pressure gas. However, such a gas may experience lower heat transfer efficiencies.

The cooling system 100c shown in FIG. 4 can also include an expansion valve 72 that is positioned along the cooling loop 102. The expansion valve 72 can be adapted to receive a high pressure, cooled flow of the working fluid and expand the working fluid relatively rapidly to lower the pressure and lower the temperature of the expanded working fluid relative to the incoming flow of working fluid to the expansion valve 72. A variety of different types of expansion valves can be utilized for the expansion valve 72. Additionally, in some forms, the expansion ratio of the expansion valve 72 can be fixed and/or adjusted, including controlled to adjust thermal transfer efficiency of the cooling loop.

A variety of different types of refrigerants, or coolants, can be utilized as the working fluid with embodiments of the cooling system 100c that include an expansion valve 72. For example, according to certain embodiments, the working fluid can be a refrigerant or coolant that may change phase between locations in the cooling loop 102. Moreover, according to certain embodiments, the working fluid can be a liquid coolant that, when received by the expansion valve 72, can experience a phase change to gaseous coolant as a result of the expansion process.

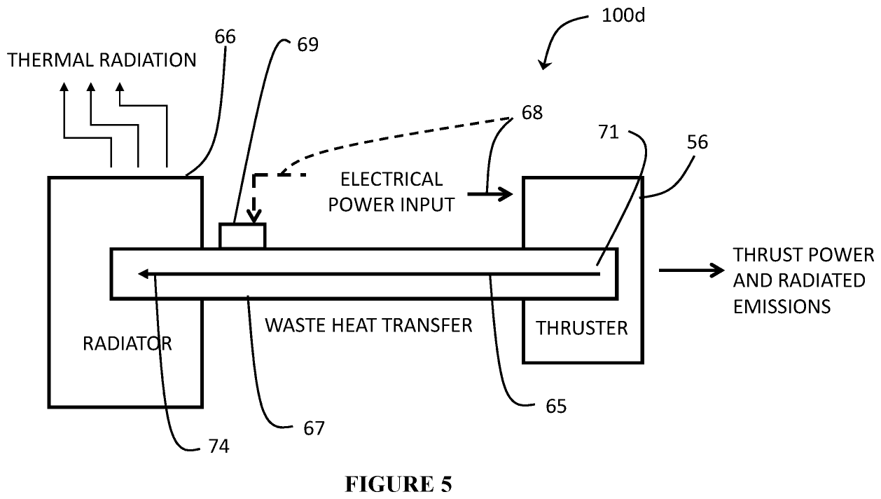

FIG. 5 illustrates another exemplary embodiment of a cooling system 100d for a cooled rocket thruster 56. The cooling system 100d shown in FIG. 5 depicts a heat pumping transfer between the rocket thruster 56 and the radiator 66 using either a thermoacoustic process or Stirling refrigeration. According to such embodiments, the working fluid remains within a conduit or tube 67 through which the waste heat 65 can be actively pumped and/or the heat entrained therein can be actively transferred. For example, according to certain embodiments, a generator 69 can be coupled to the tube 67 that can generated or emit one or more waves, such as, for example, sound or pressure waves into an interior area 71 of the tube 67 that can facilitate, via sound and differential pressures, displacement of the work fluid and/or the waste heat 65, with the heated working fluid or waste heat generally traveling toward the radiator 66, as generally indicate by the arrow 74. According to such an embodiment, a negative differential temperature can be forced to exist between the rocket thruster 56 and radiator 66 against which the energy, or waste heat 65, is pumped, and thus rocket thruster 56 can be colder than the radiator 66. As in the embodiment above in FIGS. 3 and 4, electrical power 68 can be provided not only to the rocket thruster 56, but also to power consuming components of the waste heat transfer technique, including the generator 69. The generator 69 can take a variety of different forms, including, for example, comprise a pump of a Stirling refrigerator, or, with respect to the generation of sound waves, be an acoustic generator in a thermoacoustic device).

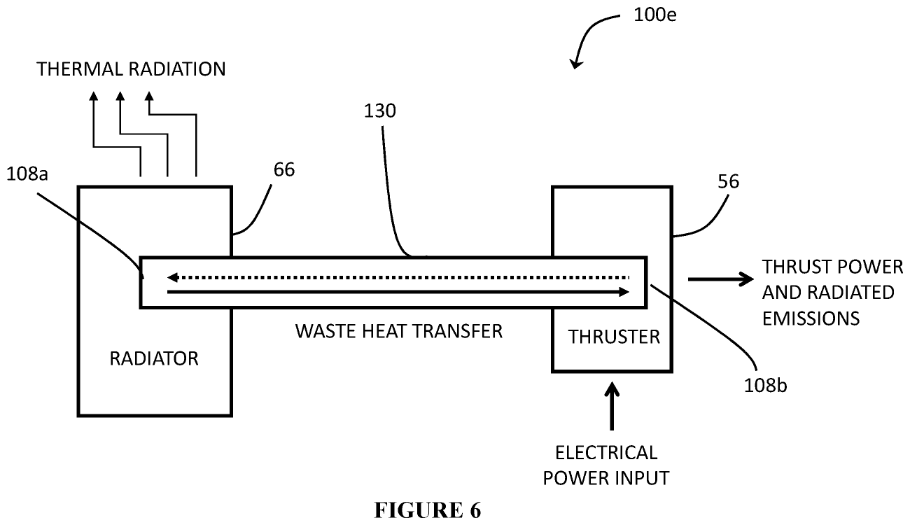

FIG. 6 depicts an exemplary embodiment of a cooling system 100e for a cooled electric rocket engine 56 that includes a heat pipe 130. The heat pipe 130 is structured to convey heat from the rocket thruster 56 to the radiator 66 via a continuous flow, and phase change of, a working fluid. A variety of different type of heat pipes can be utilized, including, for example, planar heat pipes, variable conductance heat pipes, pressure controller heat pipes, diode heat pipes, thermosyphons, and/or rotating heat pipes, among others. Moreover, according to the illustrated embodiment, a thermal gradient within the heat pipe 130 between the rocket thruster 56 and the radiator 66 can create a phase change in the working fluid, and thereby induce a flow of working fluid between each end 108a, 108b of the heat pipe 130. A flow can thereby be established via flow convection within a closed capillary system or other structure of the heat pipe 130. According to such an embodiment, a heat differential is all that is needed to facilitate flow of the working fluid, and in the preferred mode of operation the rocket thruster 56 may need to be hotter than radiator 66 to extract heat from the rocket thruster 56. Further, the use of a heat pipe 130 can serve to reduce thermal impedance to a final radiating surface.

In another embodiment a thermosyphon effect can be created using the vehicle acceleration due to rocket thruster 56 operation to impart a force on the cooled working fluid returning to the end 108b in or adjacent to the rocket thruster 56. Moreover, in such an embodiment, the cooled working fluid that may be at or leaving the radiator 66, which can be in a liquid phase, can be heavier than the heated working at or leaving the rocket thruster 56. According to such an embodiment, operation of the rocket thruster 56 can generate an acceleration of the satellite 50 that can create an artificial gravity effect. According to such an embodiment, the created artificial gravity can facilitate a flow of the relatively heavier cooled working fluid back toward and/or into the rocket thruster 56, wherein the cooled working fluid can again be used to extract heat from the rocket thruster 56.

Again, as with other embodiments discussed herein, a variety of working fluids are contemplated for use with the cooling system 100e shown in FIG. 6, and a variety of capillary cross sectional area configurations for the heat pipe 130 are also contemplated as well.

A variety of types of working fluids can be utilized with the heat pipe 130, including, but not limited to, ammonia, methanol, ethanol, or water, among others. The heat pipe 130 can also include a variety of different types of configurations to return cooled working fluid, which may be cooled to a liquid phase, from the cooled end 108a of heat pipe 130, such as, for example, the end 108a in or adjacent to the radiator 66 to the end 108b in or adjacent to the rocket thruster 56, including, for example, closest to the radiator 66 back to or towards the end 108b in or adjacent to the rocket thruster 56, including, for example, sintered metal powder, screen, and grooved wicks.

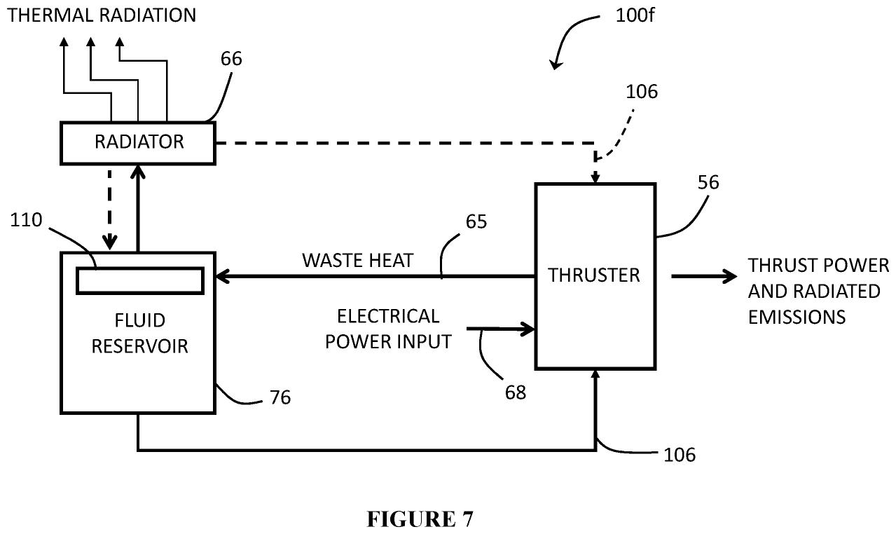

FIG. 7 depicts another exemplary embodiment of a cooling system 100f for a cooled rocket thruster 56 in which the cooling system 100f includes a working fluid reservoir 76. The fluid reservoir 76 can be structured to receive waste heat 65 entrained in the working fluid from the rocket thruster 56. Such receipt of waste heat 65, and/or the associated transport of the working fluid to the fluid reservoir 76 from the rocket thruster 56, can be via any of the methods described above, and, moreover, as discussed above with respect to other cooling systems 100a-e. Further, as illustrated, according to certain embodiments, cooled working fluid can be supplied by one or more supply lines 106 to the rocket thruster 56 from the fluid reservoir 76 and/or the radiator 66. Additionally, according to certain embodiments, cooled working fluid can be transported from the reservoir to either, or both, the fluid reservoir 76 and the rocket thruster 56.

According to the embodiment depicted in FIG. 7, a relatively substantial working fluid mass can be contained in the fluid reservoir 76. Such a mass of working fluid can be used as a thermal capacitor within the fluid reservoir 76 by absorbing rapid transient heat from returning heated working fluid at a rate that can be faster than the heat can be continuously rejected by the radiator 66. Such relatively rapid absorption of heat by the fluid mass of working fluid can enable a pulsed high-power operation of the rocket thruster 56, including high-power operation of a Hall Effect thruster, among other types of electric rocket engines. According to certain embodiments, the thermal capacitance provided by the fluid mass of the working fluid in the fluid reservoir 76 can be accomplished via a phase change and/or temperature change of the working fluid. Additionally, according to certain embodiments, such thermal capacitance provided by the fluid mass of the working fluid in the fluid reservoir 76 could also be accomplished by a secondary substance 110, including, for example, a phase change material, including, but not limited to, wax or ice, among other phase change materials, that can come into intimate contact with the heated working fluid.

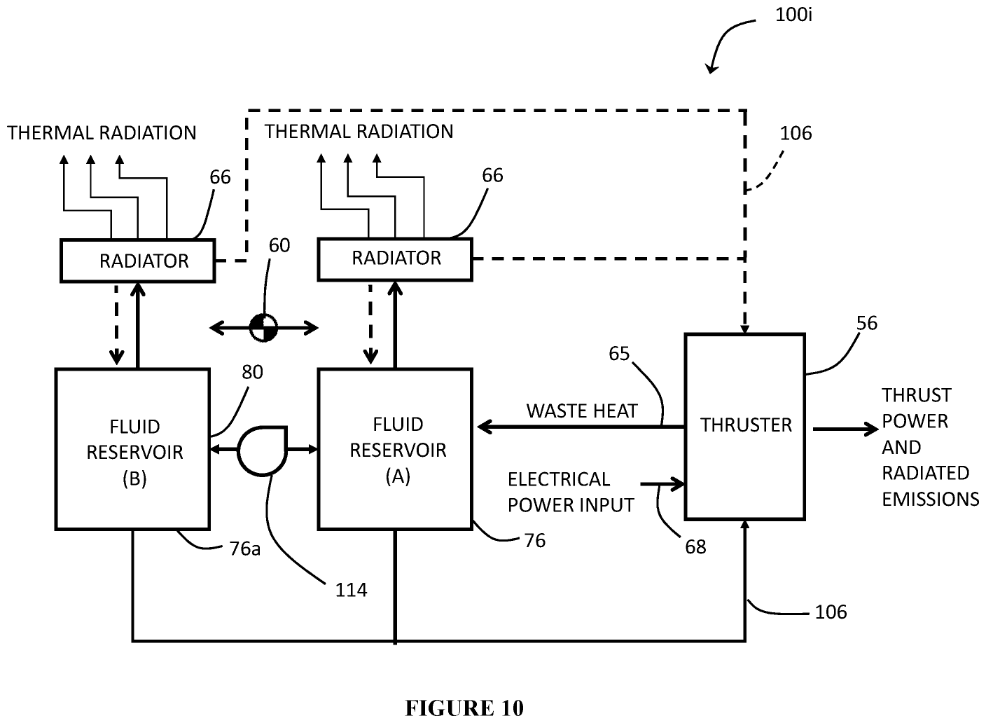

While the fluid reservoir 76 is depicted in FIG. 7 as a single unit, the fluid reservoir 76 can include one or more individual or separate fluid volumes that may be contained within the same fluid reservoir 76 or other fluid reservoirs 76, as illustrated, for example, in FIG. 10. When taken together, such individual or separate fluid volumes of the reservoir(s) 76 can form an effective thermal capacitor to absorb rapid transient heat from returning heated working fluid, as discussed above.

FIG. 8 depicts a cooling system 100g for a cooled rocket thruster 56 that is a variant of the cooling system 100f depicted in FIG. 7. Moreover, in addition to including a fluid reservoir 76 having a fluid mass of working fluid to provide a thermal capacitor, as discussed above with respect to the cooling system 100f shown in FIG. 7, the cooling system 100g shown in FIG. 8 also includes a propellant metering system 112. Moreover, FIG. 8 depicts a cooling system 100f in which the working fluid serves as both a working fluid for purposes of cooling the rocket thruster 56 and a propellant used by the rocket thruster 56 in generating a thrust force.

According to the embodiments of the cooling system 100g depicted in FIG. 8, during operation of the cooling system 100g, a portion of the working fluid in the cooling loop 102, 102′ can be diverted to the propellant metering system 112 for subsequent use as a propellant by the rocket thruster 56. For example, according to certain embodiments, working fluid in the fluid reservoir 76 and/or being delivered in one or more supply conduits 106 to the rocket thruster 56 can be diverted, such as, for example, siphoned, into a propellant supply line 132 that is in fluid communication with the propellant metering system 112. Further, according to certain embodiments, such siphoning of working fluid into the propellant supply line 132, and the associated delivery of the working fluid by the propellant supply line 132 to the propellant metering system 112 can be accomplished via use of existing pressure within the cooling loop 102, 102′. Alternatively, according to other embodiments, a dedicated flow device, such as, for example, an electrically driven gear pump or piston pump, among other pumps and devices, can be used that can directly or indirectly create a force or pressure to have working fluid flow into propellant supply line 132 and be delivered to at least the propellant metering system 112.

The propellant metering system 112 can be configured to meter or otherwise influence or control the amount of working fluid that is to be delivered to the rocket thruster 56 for use as a propellant. A variety of different types of devices can be utilized as the propellant metering system 112. For example, according to certain embodiments, the propellant metering system 112 can be a valve and/or a pump, including, for example, a variable metering valve and/or a variable displacement pump, among other devices.

The working fluid can flow from propellant metering system 112 to the rocket thruster 56, where the working fluid can be introduced into a plasma channel of the rocket thruster 56. The delivered working fluid can subsequently, via operation of the rocket thruster 56, be ionized and ejected as a reaction mass for thrust generation. According to certain embodiments, the rocket thruster 56 could exclusively consume the working fluid as a propellant. Alternatively, according to other embodiments, the working fluid can be mixed with other propellants to augment the thrust performance of the rocket thruster 56. Additionally, or alternatively, the introduction of the working fluid into the rocket thruster 56 can result in additional direct absorption and/or evaporative cooling as the working fluid is consumed in a plasma channel of the rocket thruster 56.

FIG. 9 depicts a cooling system 100h for a cooled rocket thruster 56 that is a further variation of the cooling systems 100f, 100g discussed above with respect to FIGS. 7 and 8. More specifically, as seen in FIG. 9, according to certain embodiments, the cooling system 100h can further include a fluid reaction loop 78 that is configured such that momentum (as generally indicated by “M” in FIG. 9) of fluid mass movement of the working fluid can create overall torques on the satellite 50.

The fluid reaction loop 78 can be provided in a variety of manners, including, for example, via one or more pumps that are, or are not, dedicated, to the fluid reaction loop 78. For example, according to certain embodiments, the cooling system 100h can include utilize the previously discussed pump 70 of the active cooling loop 102′ discussed above with respect to FIGS. 3 and 4 to increase the momentum of fluid mass movement of the working fluid. Additionally, or alternatively, the torqueing fluid flows can be created by the fluid flow reaction loop 78 using of separate dedicated pumps to increase the momentum of fluid mass movement of the working fluid. Further, the cooling system 102′ may include additional conduit similar to the return and/or supply lines 104, 106 that is arranged and/or positioned in a manner to further facilitate an increase in the momentum of fluid mass movement. For example, as seen in FIG. 9, according to certain embodiments, the fluid reaction loop 78 can include a reaction conduit 81 having a first end 83 that receives working fluid from the fluid reservoir 76 and a second end 85 that outputs the working fluid from the reaction conduit into the fluid reservoir 76. Alternatively, according to other embodiments, one or more flow devices, including, but not limited to, a pump or turbine, among others, may be utilized to increase the momentum of fluid mass movement of the working fluid in the fluid reservoir 76, such as, for example, directing movement of working fluid so as to generate a vortex in the fluid reservoir 76.

Thus, although the fluid reaction loop 78 is depicted in FIG. 9 as being coupled to the fluid reservoir 76, the fluid reaction loop 78 can be positioned at other locations along the cooling system 100h. Moreover, in view of the foregoing, the ability to utilize acceleration in the flow of working fluid to create torque on the satellite 50 can, for example, be attained by inducing fluid movement along a fluid reaction loop that is within the fluid reservoir 76 itself.

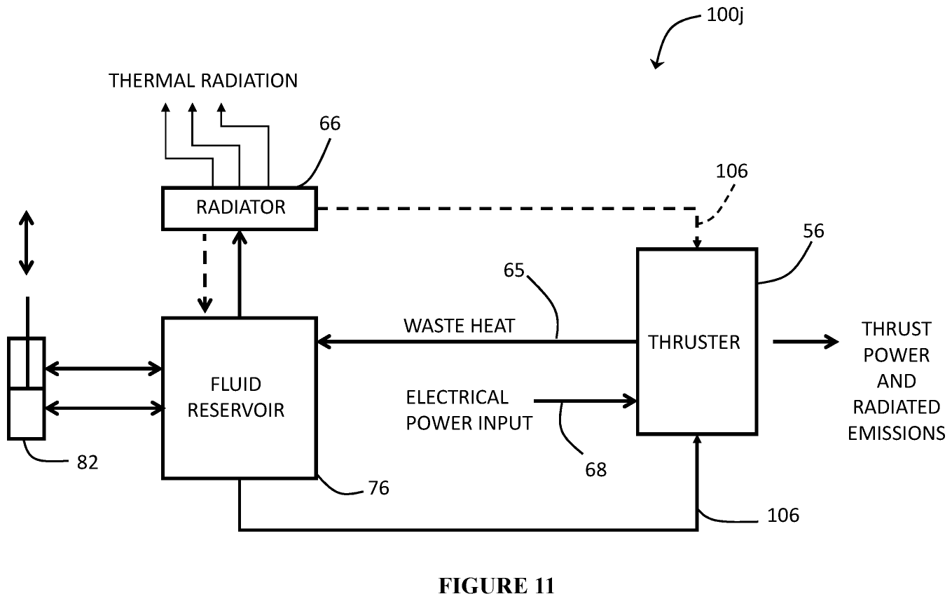

The fluid from the fluid reservoir 76 can also be used as a source of hydraulic control, whether through the pump 70 or another source of fluid power, including, for example, as supplied as a pumped or pressurized fluid that can be utilized by other hydraulic systems of the satellite 50, as further discussed below with respect to FIG. 11.

FIG. 10 depicts another embodiment of a cooling system 100i for a cooled rocket thruster 56. As previously mentioned, the cooling system 100i shown in FIG. 10 includes a first working fluid reservoir (“(A)”) 76, and at least one other, such as, for example, a second, working fluid reservoir (“(B)”) 76a. As will be appreciated, as with other cooling systems 100a-k, the cooling system 100i of FIG. 10 can be adapted further to include variations from any of the other embodiments of the cooling systems a-k discussed herein. Thus, for example, the cooling system 100i shown in FIG. 10 can include, but is not limited to, a fluid reaction loop 78, as seen in FIG. 9, that can be coupled with either or both of the working fluid reservoirs 76, 76a. According to certain embodiments, the working fluid can be pumped between the working fluid reservoirs 76, 76a, such as, for example, via a pump 114 that is in fluid communication with the working fluid reservoirs 76, 76a. Such pumping or distribution of working fluid between the working fluid reservoirs 76, 76a can be utilized to shift the center of mass 60 of the satellite 50, which can, for example, be utilized to adjust an altitude of the satellite 50. Additionally, managing the location of the center of mass 60, such as, for example, via a redistribution of the fluid mass of working fluid in each of the working fluid reservoirs 76, 76a can also assist in reducing a torque imbalance on the satellite 50, and thus reduce a tendency of the satellite 50 to rotate as a result of the torque.

According to certain embodiments, the plurality of fluid reservoirs 76, 76a can be in a vertically oriented relative to each other such that the center of mass of the working fluid contained collectively by the fluid reservoirs 76, 76a can be selectively vertically adjusted via changes in the amount of working fluid contained in each fluid reservoirs 76, 76a. For example, according to certain embodiments, the fluid reservoirs 76, 76a can be vertically stacked such that one of the fluid reservoirs 76, 76a is at a higher location than the other fluid reservoir 76, 76a. Additionally, or alternatively, one of the fluid reservoirs 76, 76a can be positioned along a bottom area of, or within, the fuselage 52, and the other fluid reservoir 76, 76a is positioned along a top are of, or within, the fuselage 52. According to other embodiments, the fluid reservoirs 76, 76a can be positioned at opposing sides of the satellite 50 and/or fuselage 52.

FIG. 11 depicts yet another cooling system 100j for a cooled rocket thruster 56 that includes at least one working fluid reservoir 76. As seen in FIG. 11, the depicted cooling system 100i can further include a fluid driven device or system 82, such as, for example, a hydraulic system of the satellite 50 that may perform functions not directly related to cooling the rocket thruster 56.

According to such an embodiment, working fluid can be extracted or otherwise delivered from the cooling loop 102, 102′, including, for example, from the fluid reservoir 76, radiator 66, and/or return line 106, and delivered to a pump of the fluid driven system 82. The pump of the fluid driven system 82 can pump the working fluid in a manner similar to traditional hydraulic/pneumatic mechanical systems for subsequent use in altering the shape, deployment, position of vehicle systems and structures of the satellite 50. The placement and use of the fluid driven device 82 can be dependent on the application. In a few non-limiting examples, the fluid driven device 82 could be used to alter the orientation of the rocket thruster 56, change a center of mass 60 of the vehicle satellite 50 to impart spacecraft attitude torques, and/or raise/lower a flap on a fin 54 of the satellite 50, among other operations. Additionally, the working fluid can be delivered to one or more fluid mechanism driven devices 82 of the satellite 50. While the foregoing discusses use of a pump of the fluid driven system 82, according to other embodiments, the cooling system 100j can include an active cooling loop 102′, and the pump 70 of the active cooling loop 102′ can be operated to pressurize the working fluid for use in a hydraulic/pneumatic mechanical system of the one or more fluid driven devices or systems 82.

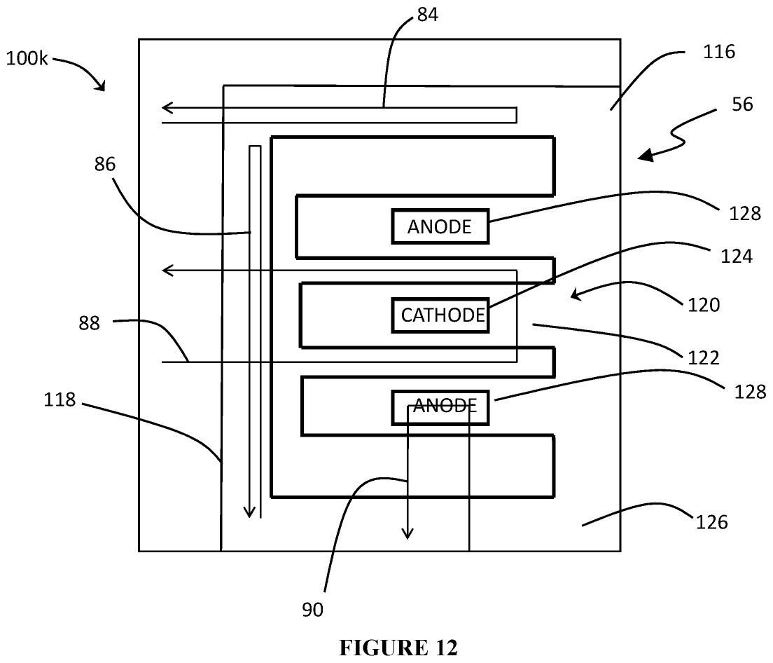

Turning now to FIG. 12, various working fluid pathways 84, 86, 88, 90 that at least pass through a portion of the rocket thruster 56 are illustrated which can be used to provide cooling to the rocket thruster 56. Although FIG. 12 illustrates several pathways 84, 86, 88, 90 are illustrated to cool four separate regions of the rocket thruster 56, not all pathways 84, 86, 88, 90 need be used in all embodiments.

According to the illustrated embodiment, a pathway 84 for working fluid can be used to convey working fluid into thermal conductive relationship with a shell 116 of the rocket thruster 56. It will be appreciated that the shell 116 can be made of a single or multiple pieces of the shell 116, and that the pathway 84 can extend along only one or more than one of the pieces of the shell 116. The pathway 84 can be formed integral with the shell 116, or can be affixed to the shell 116 so long as thermal conductive relationship is maintained to ensure adequate heat transfer from the shell 116 to the working fluid.

In similar manner, another pathway 86 for working fluid can be used to convey working fluid into a thermal conductive relationship with a back side 118 of the rocket thruster 56. It will be appreciated that the back side 118 can be made of a single or multiple pieces, and that the pathway 86 can extend along only one or more than one of the pieces of the back side 118. The pathway 86 can be formed integral with the back side 118, and/or can be affixed to the back side 118, so long as thermal conductive relationship is maintained to ensure adequate heat transfer from the back side 118 of the rocket thruster 56 to the working fluid.

Additionally, or alternatively, as also seen in FIG. 12, a pathway 88 for working fluid can be provided in a center pole 120 of the rocket thruster 56. According to certain embodiments, the pathway 88 for the working fluid can be embedded in the center pole. It will be appreciated that the schematic illustrated in FIG. 12 represents a cross section of an annular structure or construction of the rocket thruster 56. Thus, although the pathway 88 appears in FIG. 12 to cross a gap 122 from one side of the cathode 124 to the other, the pathway 88 is rather formed within the annular structure 126 of the rocket thruster 56. Thus, the crossing nature of the pathway 88 illustrated in FIG. 12 is intended to convey the passing of cooling pathway 88 along the annular structure 126 of the rocket thruster 56. Further, according to certain embodiments, the pathway 88 can be provided around substantially all of the annular structure 126 of the rocket thruster 56, while according to other embodiments the pathway 88 may only extend partially around the annular structure 126. Additionally, although only one pathway 88 is illustrated in FIG. 12, several different pathways 88 can be embedded in the center pole 120. Further, although FIG. 12 depicts an internal cathode 124, in other embodiments the rocket thruster 56 can have an external cathode. Such embodiments in which the cathode 124 is an external cathode can also have one or more pathway(s) 88 embedded in the center pole 120 for passage of working fluid.

Pathway 90 can be provided to pass working fluid for the anode 128 of the rocket thruster 56. In some forms the pathway 90 is embedded in the anode 128, or, alternatively, pass across a gap in which the anode 128 is positioned, or which is adjacent to the anode 128. Although the depiction in the schematic of FIG. 12 suggests that the cooling pathway 90 may enter and exit the anode 128 at the same circumferential location, in some forms the cooling pathway 90 may extend and arc along the annular anode 128 for some distance before exiting and flowing to the radiator 66. In addition, although the illustrated embodiment depicts just a single pathway 90, additional pathways 90 can also be included to provide cooling for the annular anode 128.

According to certain embodiments, the working fluid can be actively transported, such as, for example, via the previously discussed pump 70 and/or via a heat pipe based system, as discussed above for example with respect to FIG. 6, to flow through one or more, if not all, of the pathways 84, 86, 88, 90. Additionally, as previously mentioned, the active cooling of the rocket thruster 56 can apply to both internal and external cathode style electric rocket engines.

One aspect of the present application includes an apparatus comprising: an orbital vehicle structured for flight in the thermosphere, a hall thruster coupled with the orbital vehicle and structured to provide vehicle propulsive power during orbital operation, and a heat exchange system including a heat exchange fluid, the heat exchange system structured to convey heat from the hall thruster to a heat exchange fluid as a result of hall thruster operation.

A feature of the present application includes wherein the orbital vehicle includes a longitudinal axis and at least one swept fin oriented at an angle relative to the longitudinal axis, the at least one swept fin at an oblique angle to the velocity vector of the orbital vehicle during orbit.

Another feature of the present application includes wherein the orbital vehicle includes a telescope oriented to capture an image at an angle transverse to the longitudinal axis.

Still another feature of the present application includes wherein the orbital vehicle includes a radiator structured to receive the heat exchange fluid after it has received heat from the hall thruster.

Yet another feature of the present application includes wherein the heat exchange system further includes a fluid flow channel in thermal communication with the hall thruster, and wherein the heat exchange fluid flows through the fluid flow channel to receive heat and thence to the radiator to reject the heat from the orbital vehicle.

Still yet another feature of the present application includes wherein the heat exchange system includes a pump with a moveable mechanical member used to provide the conveyance of the heat exchange fluid through the channel.

Yet still another feature of the present application includes wherein the moveable mechanical member includes one of a piston, diaphragm, and impeller.

Yet still another feature of the present application includes wherein the heat exchange fluid is a refrigerant fluid.

Yet still another feature of the present application includes wherein the heat exchange system includes an expansion valve structured to provide an expansion of the heat exchange fluid such that a relatively high pressure heat exchange fluid is expanded to relatively low pressure through the expansion valve to provide a temperature drop in the heat exchange fluid.

Yet still another feature of the present application includes wherein the transfer of heat between the hall thruster and the heat exchange fluid occurs via a thermoacoustic process.

Yet still another feature of the present application includes wherein the transfer of heat between the hall thruster and the heat exchange fluid occurs via a Stirling refrigeration process.

Yet still another feature of the present application includes wherein the heat exchange system includes a heat pipe within which the heat exchange fluid flows, wherein the heat pipe is structured to permit a two-phase flow of the heat exchange fluid.

Yet still another feature of the present application further includes a first fluid reservoir disposed in heat transfer relationship between the hall thruster and the radiator.

Yet still another feature of the present application includes wherein the heat exchange fluid is a propellant for the hall thruster.

Yet still another feature of the present application further includes a second fluid reservoir disposed in fluid communication with the first fluid reservoir, the heat exchange system structured to transfer heat exchange fluid to the second fluid reservoir and thereby change a center of gravity of the orbital vehicle.

Yet still another feature of the present application further includes a fluid pump in fluid communication with at least one of the first and second fluid reservoirs, the fluid pump structured to convey heat exchange fluid to a fluid receiving component of the orbital vehicle so as to impart work to the fluid receiving component.

Yet still another feature of the present application includes wherein the orbital vehicle further includes a propellant metering system in fluid communication with the fluid reservoir, the propellant metering system structured to meter the flow of propellant to the hall thruster.

Yet still another feature of the present application includes wherein the fluid reservoir includes a fluid loop having a discharge from the fluid reservoir and a return to the fluid reservoir, the fluid loop sized to generate a torque on the orbital vehicle as a result of a flow of the heat transfer fluid through the fluid loop.

Yet still another feature of the present application includes wherein the Hall Effect thruster includes a shell that encloses at least a part of a magnetic structure used to generate propulsive force, the shell having a coolant fluid flow path structured to receive the heat exchange fluid.

Yet still another feature of the present application includes wherein the Hall Effect thruster includes a center pole having a cooling loop embedded therein for the receipt of the heat exchange fluid.

Yet still another feature of the present application includes wherein the Hall Effect thruster includes an anode having a cooling loop embedded therein for the receipt of the heat exchange fluid.

Yet still another feature of the present application includes wherein the hall effect thruster includes a front side configured to discharge a flow of ions as a result of operation of the hall effect thrust, and a back side opposite the front side in which a cooling loop is embedded to flow the heat exchange fluid and withdraw heat from the hall effect thruster.

Another aspect of the present application includes an apparatus comprising: an orbital vehicle structured to operate in the thermosphere, the vehicle having an actively cooled ion thruster, the ion thruster structured to produce a thrust useful to discourage orbital decay from operation of the orbital vehicle in the thermosphere, the ion thruster in thermal communication with a thermal exchange fluid.

A feature of the present application includes wherein the orbital vehicle includes at least one swept fin having a leading edge with a material composition structured for orbital velocity flight in the thermosphere, the at least one swept fin oriented at an oblique angle relative to a velocity vector angle of the orbital vehicle during orbit.

Another feature of the present application includes wherein the orbital vehicle includes a telescope payload having a camera sensor structured to receive optical light along a longitudinal axis of the orbital vehicle, the telescope payload including a first mirror oriented to capture an image at a transverse angle to the longitudinal axis of the orbital vehicle.

Still another feature of the present application includes wherein the orbital vehicle includes a thermal radiator structured to receive the heat exchange fluid after it has received heat from the hall thruster and radiate heat from the heat exchange fluid into space.

Yet another feature of the present application includes wherein the heat exchange system further includes a fluid flow channel in thermal communication with the hall thruster, and wherein the heat exchange fluid flows through the fluid flow channel to receive heat and thence to the thermal radiator to reject the heat from the orbital vehicle.

Still yet another feature of the present application includes wherein the heat exchange system includes a pump with a moveable mechanical member used to provide the conveyance of the heat exchange fluid through the channel.

Yet still another feature of the present application includes wherein the moveable mechanical member includes one of a piston, diaphragm, and impeller.

Yet still another feature of the present application includes wherein the heat exchange fluid is a refrigerant fluid.

Yet still another feature of the present application includes wherein the heat exchange system includes an expansion valve structured to provide an expansion of the heat exchange fluid such that a relatively high pressure heat exchange fluid is expanded to relatively low pressure through the expansion valve to provide a temperature drop in the heat exchange fluid.

Yet still another feature of the present application includes wherein the transfer of heat between the hall thruster and the heat exchange fluid occurs via a thermoacoustic process.

Yet still another feature of the present application includes wherein the transfer of heat between the hall thruster and the heat exchange fluid occurs via a Stirling refrigeration process.

Yet still another feature of the present application includes wherein the heat exchange system includes a heat pipe within which the heat exchange fluid flows, wherein the heat pipe is structured to permit a two-phase flow of the heat exchange fluid.

Yet still another feature of the present application further includes a first fluid reservoir disposed in heat transfer relationship between the hall thruster and the thermal radiator.

Yet still another feature of the present application includes wherein the heat exchange fluid is a propellant for the hall thruster.

Yet still another feature of the present application further includes a second fluid reservoir disposed in fluid communication with the first fluid reservoir, the heat exchange system structured to transfer heat exchange fluid to the second fluid reservoir and thereby change a center of gravity of the orbital vehicle.

Yet still another feature of the present application further includes a fluid pump in fluid communication with at least one of the first and second fluid reservoirs, the fluid pump structured to convey heat exchange fluid to a fluid receiving component of the orbital vehicle so as to impart work to the fluid receiving component.

Yet still another feature of the present application includes wherein the orbital vehicle further includes a propellant metering system in fluid communication with the fluid reservoir, the propellant metering system structured to meter the flow of propellant to the hall thruster.

Yet still another feature of the present application includes wherein the fluid reservoir includes a fluid loop having a discharge from the fluid reservoir and a return to the fluid reservoir, the fluid loop sized to generate a torque on the orbital vehicle as a result of a flow of the heat transfer fluid through the fluid loop.

Yet still another feature of the present application includes wherein the Hall Effect thruster includes a shell that encloses at least a part of a magnetic structure used to generate propulsive force, the shell having a coolant fluid flow path structured to receive the heat exchange fluid.

Yet still another feature of the present application includes wherein the Hall Effect thruster includes a center pole having a cooling loop embedded therein for the receipt of the heat exchange fluid.

Yet still another feature of the present application includes wherein the Hall Effect thruster includes an anode having a cooling loop embedded therein for the receipt of the heat exchange fluid.

Yet still another feature of the present application includes wherein the hall effect thruster includes a front side configured to discharge a flow of ions as a result of operation of the hall effect thrust, and a back side opposite the front side in which a cooling flow path is embedded to flow the heat exchange fluid and withdraw heat from the hall effect thruster.

Yet another aspect of the present application includes a method comprising: orbiting the earth with an orbital vehicle having a hall effect thruster, producing thrust with the hall effect thruster to propel the orbital vehicle, creating heat as a result of producing thrust with the hall effect thruster, and transferring the heat produced from the hall effect thruster to a heat exchange fluid.

A feature of the present application further includes capturing an optical image of earth out of a bottom of the orbital vehicle and optically turning the optical image using at least a first optical member to a direction along a body length of the orbital vehicle, and which further includes receiving the optically turned optical image in a camera sensor at an end of the orbital vehicle associated with a forward direction of flight.

Another feature of the present application further includes receiving the heat exchange fluid in a thermal radiator after the heat exchange fluid has received heat from the hall thruster, and radiating heat from the heat exchange fluid into space.

Still another feature of the present application further includes flowing the heat exchange fluid in a fluid flow channel that is in thermal communication with the hall thruster, and which further includes flowing the heat exchange fluid to the thermal radiator to reject the heat from the orbital vehicle.

Yet feature of the present application further includes operating a pump having a moveable mechanical member to provide the conveyance of the heat exchange fluid through the fluid flow channel.

Still yet another feature of the present application includes wherein the moveable mechanical member includes one of a piston, diaphragm, and impeller.

Yet still another feature of the present application includes wherein the heat exchange fluid is a refrigerant fluid.

Yet still another feature of the present application further includes expanding the heat exchange fluid through an expansion valve to provide an expansion of the heat exchange fluid such that a relatively high pressure heat exchange fluid is expanded to relatively low pressure through the expansion valve to provide a temperature drop in the heat exchange fluid.

Yet still another feature of the present application further includes transferring heat between the hall thruster and the heat exchange fluid via a thermoacoustic process.

Yet still another feature of the present application further includes transferring heat between the hall thruster and the heat exchange fluid via a Stirling refrigeration process.

Yet still another feature of the present application further includes transferring heat between the hall thruster and the heat exchange fluid in a heat pipe, wherein the heat pipe is structured to permit a two-phase flow of the heat exchange fluid.

Yet still another feature of the present application further includes flowing the heat exchange fluid to a first fluid reservoir disposed in heat transfer relationship between the hall thruster and the thermal radiator.

Yet still another feature of the present application includes wherein the heat exchange fluid is a propellant for the hall thruster.

Yet still another feature of the present application further includes flowing the heat exchange fluid to a second fluid reservoir disposed in fluid communication with the first fluid reservoir, and changing a center of gravity of the orbital vehicle when fluid is flowed to the second fluid reservoir.

Yet still another feature of the present application further includes operating a fluid pump in fluid communication with at least one of the first and second fluid reservoirs, the fluid pump structured to convey heat exchange fluid to a fluid receiving component of the orbital vehicle so as to impart work to the fluid receiving component.

Yet still another feature of the present application further includes metering the flow of propellant to the hall thruster with a propellant metering system.

Yet still another feature of the present application further includes flowing the heat exchange fluid through a loop coupled with the fluid reservoir, the fluid loop having a discharge from the fluid reservoir and a return to the fluid reservoir, the fluid loop sized to generate a torque on the orbital vehicle as a result of flowing the heat transfer fluid through the fluid loop.

Yet still another feature of the present application further includes flowing the heat exchange fluid through a shell of the Hall Effect thruster, the shell enclosing at least a part of a magnetic structure used to generate propulsive force.

Yet still another feature of the present application further includes flowing the heat exchange fluid through a center pole of the hall thruster.

Yet still another feature of the present application further includes flowing the heat exchange fluid through an anode of the Hall Effect thruster.

Yet still another feature of the present application includes wherein the hall effect thruster includes a front side configured to discharge a flow of ions as a result of operation of the hall effect thrust, and a back side opposite the front side in which a cooling flow path is embedded to flow the heat exchange fluid and withdraw heat from the hall effect thruster, and which further includes flowing the heat exchange fluid through the cooling flow path in the back side.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

1. An apparatus comprising:
an electric rocket engine;
a cooling system having at least one radiator and structured to convey a heat generated by operation of the electric rocket engine to a working fluid, the cooling system further structured to radiate heat from the working fluid into space through at least one radiator; and
a propellant metering system fluidly coupled to the cooling system and the electric rocket engine, the propellant metering system adapted to control a delivery of a portion of the working fluid from the cooling system to the electric rocket engine, wherein the portion of the working fluid is a propellant for generation of a thrust force by the electric rocket engine.

2. The apparatus of claim 1, wherein the cooling system further includes at least one pump structured to impart a force onto the working fluid.

3. The apparatus of claim 2, wherein the cooling system further includes an expansion valve structured and positioned to provide an expansion of the working fluid such that a pressure and a temperature of the working fluid are reduced prior to the working fluid being delivered from the radiator to the electric rocket engine.

4. The apparatus of claim 3, wherein the expansion valve is adapted to facilitate a phase change of the working fluid.

5. The apparatus of claim 1, wherein the cooling system further includes a tube and a generator, the tube at least extending between the electric rocket engine and the at least one radiator, the working fluid being confined to an interior area of the tube, the generator adapted to emit one or more pressure waves or sound waves into the interior area to facilitate a transfer of a waste heat in the working fluid to the at least one radiator.

6. The apparatus of claim 5, wherein the generator is a pump of a Stirling refrigerator.

7. The apparatus of claim 5, wherein the generator is an acoustic generator of a thermoacoustic device.

8. The apparatus of claim 1, wherein the cooling system further includes a heat pipe within which the working fluid flows, the heat pipe being structured to permit a two-phase flow of the working fluid.

9. The apparatus of claim 1, wherein the cooling system further includes at least one fluid reservoir disposed in a heat transfer relationship between the electric rocket engine and the at least one radiator.

10. The apparatus of claim 9, wherein the at least one fluid reservoir includes a phase change material positioned within the at least one fluid reservoir to come into contact with the working fluid.

11. The apparatus of claim 9, wherein the at least one fluid reservoir is sized to contain a mass of working fluid such that the working fluid within the at least one fluid reservoir provides a thermal capacitor that absorbs rapid transient heat from heated working fluid at a rate that can be faster than heat can be continuously radiated by the at least one radiator.

12. The apparatus of claim 9, wherein the at least one fluid reservoir includes a fluid loop configured to generate a torque on the apparatus as a result of a flow of the working fluid through the fluid loop.

13. The apparatus of claim 12, wherein the fluid loop is adapted to generate a vortex in the at least one fluid reservoir.

14. The apparatus of claim 9, wherein the at least one fluid reservoir comprises a first fluid reservoir and a second fluid reservoir, the second fluid reservoir disposed in fluid communication with the first fluid reservoir, the cooling system structured to selectively transfer working fluid between the first fluid reservoir and the second fluid reservoir to control a position of a center of gravity of the apparatus.

15. The apparatus of claim 14, wherein the at least one radiator comprises a first radiator and a second radiator, the first radiator being in fluid communication with the first fluid reservoir, the second radiator being in fluid communication with the second fluid reservoir.

16. The apparatus of claim 9, further including a fluid pump in fluid communication with the at least one fluid reservoir, the fluid pump structured to convey working fluid to a fluid receiving component of the apparatus to impart work to the fluid receiving component.

17. The apparatus of claim 1, wherein the electric rocket engine includes a shell that encloses at least a part of a magnetic structure used to generate a propulsive force, and wherein the cooling system includes a working fluid flow path that extends into the shell, the working fluid flow path being structured to receive the working fluid.

18. The apparatus of claim 1, wherein the electric rocket engine includes a center pole, and wherein the cooling system includes a cooling loop embedded within the center pole and configured to receive the working fluid.

19. The apparatus of claim 1, wherein the electric rocket engine includes an anode, and wherein the cooling system includes a cooling loop embedded within the anode and configured to receive the working fluid.

20. The apparatus of claim 1, wherein the electric rocket engine includes a front side configured to discharge a flow of ions as a result of operation of the electric rocket engine, and a back side opposite the front side in which a cooling loop of the cooling system is embedded, the cooling loop structured to receive a flow the working fluid to withdraw heat from the electric rocket engine.
